(19) United States
(12) Patent Application Publication
(10) Pub. No.: US 2022/0379905 A1
(43) Pub. Date: Dec. 1, 2022

(54) VEHICLE TRANSFER ASSISTANCE SYSTEM

(71) Applicant: AISIN CORPORATION, Kariya (JP)

(72) Inventor: Keita TAKAGI, Kariya-shi (JP)

(73) Assignee: AISIN CORPORATION, Kariya (JP)

(21) Appl. No.: 17/656,950

(22) Filed: Mar. 29, 2022

(30) Foreign Application Priority Data
May 26, 2021 (JP) 2021-088483

(51) Int. Cl. B60W 50/10; B60W 40/09

(52) U.S. Cl. CPC B60W 50/10; B60W 40/09; B60W 2040/0872

(57) ABSTRACT

A vehicle transfer assistance system includes an adjustment position acquisition unit configured to acquire an adjustment position of a seat element set in a boarded vehicle boarded by a user, a specific distance calculation unit configured to calculate, based on the acquired adjustment position, a predetermined specific distance around a seat of the boarded vehicle formed by the seat element, the specific distance being associated with a physical feature of the user sitting on the seat,

a specific distance storing unit configured to store the user and the specific distance in association with each other, and a converted adjustment position calculation unit configured to calculate a converted adjustment position that is the adjustment position of the seat element for reproducing the specific distance in a transfer vehicle different from the boarded vehicle when the user boards on the transfer vehicle.

### CROSS REFERENCE TO RELATED APPLICATIONS

This application is based on and claims priority under 35 U.S.C. § 119 to Japanese Patent Application 2021-088483, filed on May 26, 2021, the entire content of which is incorporated herein by reference.

### TECHNICAL FIELD

This disclosure relates to a vehicle transfer assistance system.

### BACKGROUND DISCUSSION

In related art, as a vehicle transfer assistance system that facilitates vehicle transfer, there has been a vehicle transfer assistance system that enables to take over a seat position such that a sitting posture of the user does not change even after transferring between vehicles. For example, a seat position control device described in JP 2010-195169A (Reference 1) measures a distance between a specific position in a vehicle cabin and a specific part of a driver. A seat position of the vehicle is adjusted such that the measured distance matches distance measurement data stored in advance.

However, for example, as ownership of a vehicle changes, such as use of car rental services and car sharing, a frequency of transfer tends to increase as well. Further, due to diversification of vehicle design, a sitting posture of an occupant also varies greatly from vehicle to vehicle. The above structure in the related art cannot necessarily meet such an evolving demand level, and is thus required further improvement.

### SUMMARY

According to an aspect of this disclosure, a vehicle transfer assistance system includes: an adjustment position acquisition unit configured to acquire an adjustment position of a seat element set in a boarded vehicle boarded by a user; a specific distance calculation unit configured to calculate, based on the acquired adjustment position, a predetermined specific distance around a seat of the boarded vehicle formed by the seat element, the specific distance being associated with a physical feature of the user sitting on the seat; a specific distance storing unit configured to store the user and the specific distance in association with each other; and a converted adjustment position calculation unit configured to calculate a converted adjustment position that is the adjustment position of the seat element for reproducing the specific distance in a transfer vehicle different from the boarded vehicle when the user boards on the transfer vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic configuration diagram of a vehicle transfer assistance system;

FIG. 2 is a schematic diagram around a driver seat in a sedan-type vehicle;

FIG. 3 is a schematic diagram around a driver seat in a minivan-type vehicle;

FIG. 4 is a schematic configuration diagram of the vehicle transfer assistance system;

FIG. 5 is a schematic configuration diagram of a conversion database;

FIG. 6 is a schematic configuration diagram of a user database;

FIG. 7 is a flowchart showing a processing procedure before transfer;

FIG. 8 is a flowchart showing a processing procedure during the transfer; and

FIG. 9 is an explanatory diagram of a vehicle transfer assistance system according to an alternative embodiment.

### DETAILED DESCRIPTION

Hereinafter, an embodiment of a vehicle transfer assistance system will be described with reference to drawings.

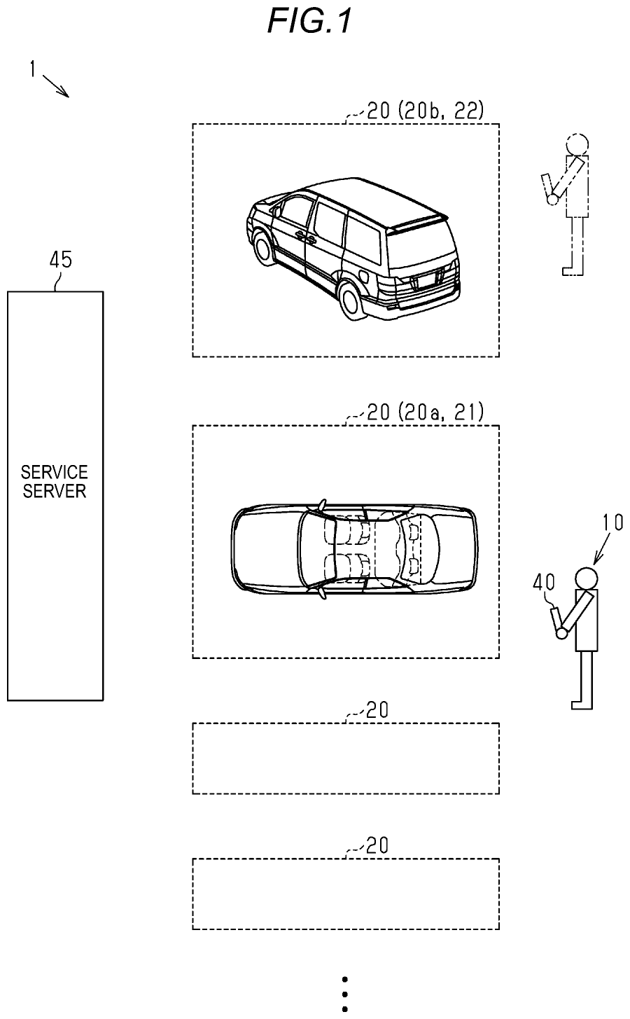

As shown in FIG. 1, a vehicle transfer assistance system 1 according to the present embodiment is used for, for example, car sharing, car rental services, or the like, in which a user 10 can select and board on a boarded vehicle 21 from among a plurality of vehicles 20.

Specifically, when the user 10 transfers between the vehicles 20, the vehicle transfer assistance system 1 of the present embodiment assists a seat position adjustment performed in the vehicle 20 after the transfer, that is, in a transfer vehicle 22. Accordingly, the user 10 of the vehicle transfer assistance system 1 can secure a suitable sitting posture even after transferring between the vehicles 20.

For example, consider a case where the user 10 transfers from a sedan-type vehicle 20a to a minivan-type vehicle 20b. In this case, the vehicle 20a before the transfer is the boarded vehicle 21, and the vehicle 20b after the transfer is the transfer vehicle 22. Transfer may be performed at any interval. After getting off the vehicle 20a, the user 10 may directly get on the vehicle 20b, or may, for example, get on the vehicle 20b after several days, several months, or several years.

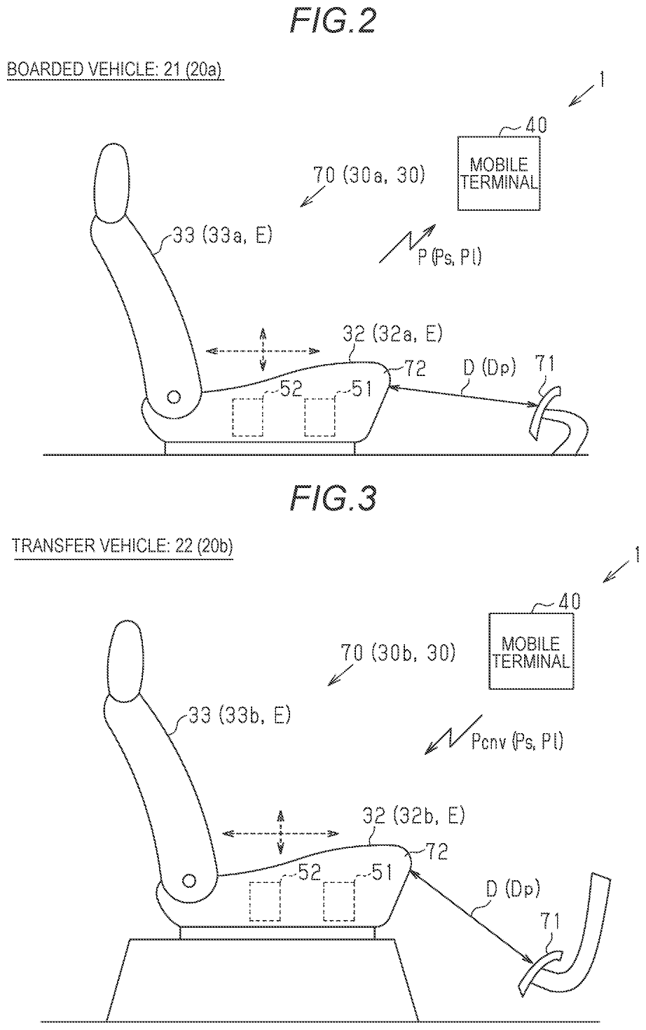

As shown in FIGS. 2 and 3, comparing these vehicles 20a and 20b, arrangement of seat elements E forming seats 30a and 30b varies depending on the vehicle design. That is, the seat 30a, 30b of the vehicle 20a, 20b includes, as a seat element E thereof, a seat cushion 32a, 32b constituting a sitting surface and a seatback 33a, 33b constituting a backrest surface of the seat 30a, 30b. In many cases, the seat cushion 32b in the minivan-type vehicle 20b is arranged at a higher position than the seat cushion 32a in the sedan-type vehicle 20a. Therefore, when transferring from the vehicle 20a to the vehicle 20b, a position of the seat cushion 32b is normally adjusted to secure a suitable sitting posture even after the transfer.

As shown in FIGS. 1 to 3, in the vehicle transfer assistance system 1 according to the present embodiment, when transferring between the vehicles 20, a mobile terminal 40 held by the user 10 communicates with each of the boarded vehicle 21 before the transfer and the transfer vehicle 22 after the transfer among the vehicles 20. At this time, the mobile terminal 40 also communicates with a service server 45 connected via the Internet (not shown). The mobile terminal 40 may be, for example, a smartphone, a tablet, or the like. The vehicle transfer assistance system 1 according to the present embodiment assists the seat position adjustment in the transfer vehicle 22 by communication via the mobile terminal 40 of the user 10.

Specifically, as shown in FIGS. 2 and 3, in the vehicle transfer assistance system 1 according to the present embodiment, the vehicles 20 serving as the boarded vehicle 21 and the transfer vehicle 22 each include a seat slide device 51 and a lifter device 52 provided in a seat 30. Based on operations of the seat slide device 51 and the lifter device 52, a front-rear position and an upper-lower position of the seat cushion 32 forming the seat 30 can be adjusted, respectively.

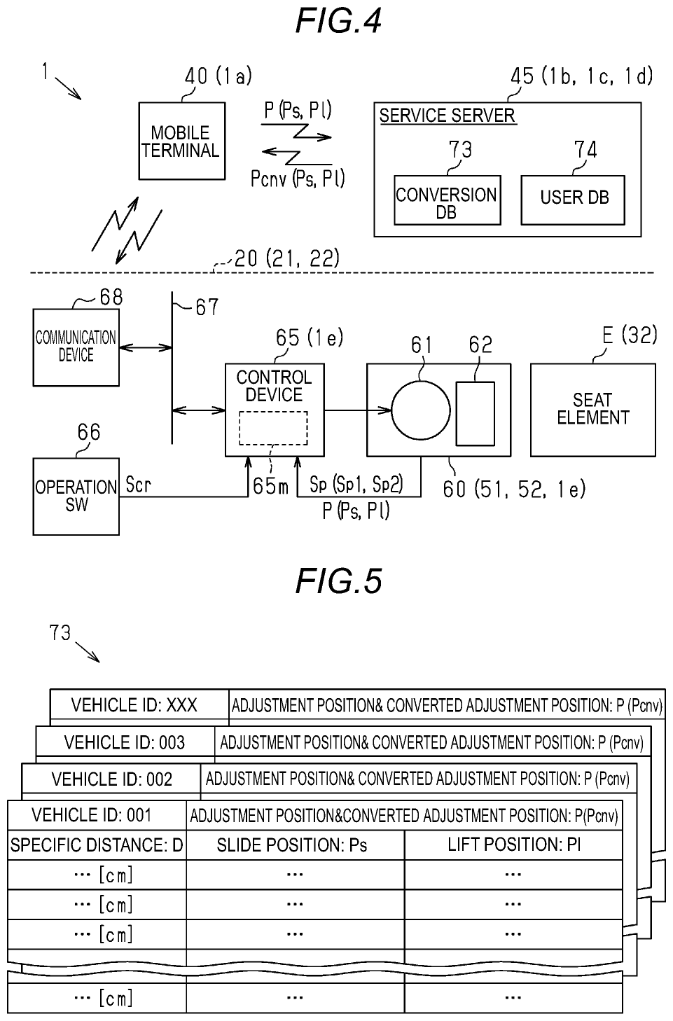

Specifically, as shown in FIG. 4, actuators 60 constituting the seat slide device 51 and the lifter device 52 each include a motor 61 serving as a drive source, and a conversion mechanism 62 that converts a drive force of the motor into an operation of the seat element E to be driven. That is, in a case of the seat slide device 51 and the lifter device 52, the seat element E to be driven is the seat cushion 32. Each actuator 60 supplies drive power to the motor 61 under the control of a control device 65. Accordingly, each vehicle 20 is configured such that position adjustment of the seat cushion 32 is executed by the control device 65 based on an operation of each actuator 60, that is, the operations of the seat slide device 51 and lifter device 52.

More specifically, a pulse signal Sp synchronized with the operation of each actuator 60 is input to the control device 65 according to the present embodiment. The control device 65 detects an adjustment position P of the seat element E to be driven of the actuator 60 by counting the pulse signal Sp.

That is, a pulse signal Sp1 synchronized with the actuator 60 constituting the seat slide device 51 and a pulse signal Sp2 synchronized with the actuator 60 constituting the lifter device 52 are input to the control device 65 according to the present embodiment. Further, the control device 65 counts the pulse signal Sp1 to detect a slide position Ps of the seat cushion 32 as the adjustment position P of the seat cushion 32 in a front-rear direction of the vehicle based on the operation of the seat slide device 51. The control device 65 counts the pulse signal Sp2 to detect a lift position PI of the seat cushion 32 as the adjustment position P of the seat cushion 32 in an upper-lower direction of the vehicle based on the operation of the lifter device 52.

The slide position Ps is represented by, for example, a pulse count value or the like based on a limit position in the front-rear direction that can be adjusted based on the operation of the seat slide device 51, that is, a front end position or a rear end position. Similarly, the lift position PI is represented by, for example, a pulse count value or the like based on a limit position in the upper-lower direction that can be adjusted based on the operation of the lifter device 52, that is, an upper end position or a lower end position.

For example, an operation input signal Scr to an operation switch 66 provided in the seat 30 is input to the control device 65 according to the present embodiment. The control device 65 executes the position adjustment of the seat cushion 32 forming the seat 30 based on an operation request indicated by the operation input signal Scr and the detected adjustment position P.

Further, the control device 65 according to the present embodiment stores the adjustment position P of the seat element E set as described above in a storage area 65m. When the vehicle 20 is started, the control device 65 reads the adjustment position P stored in the storage area 65m, that is, the slide position Ps and the lift position PI of the seat cushion 32. Further, the control device 65 controls the operations of the seat slide device 51 and lifter device 52, with the slide position Ps and the lift position PI read from the storage area 65m as a control target. Accordingly, the seat 30 of each vehicle 20 applied with the vehicle transfer assistance system 1 according to the present embodiment is provided with a memory function capable of reproducing the adjustment position P of the seat element E set in advance.

The control device 65 according to the present embodiment is connected to a communication device 68 via an in-vehicle network 67. Further, the control device 65 has a function of executing external communication using the communication device 68. The control device 65 according to the present embodiment can acquire the control target when performing the position adjustment of the seat element E forming the seat 30 by executing the external communication.

As shown in FIGS. 2 and 3, the vehicle transfer assistance system 1 according to the present embodiment uses the external communication function implemented in each vehicle 20 serving as the boarded vehicle 21 and the transfer vehicle 22. Specifically, first, in the boarded vehicle 21, the mobile terminal 40 held by the user 10 acquires the adjustment position P of the seat element E set by the user 10 in the boarded vehicle 21. Next, when transferring between the vehicles 20, the mobile terminal 40 of the user 10 transmits a converted adjustment position Pcnv generated based on the adjustment position P of the seat element E in the boarded vehicle 21 acquired previously to the transfer vehicle 22 as the control target optimized for the transfer vehicle 22. Further, based on the converted adjustment position Pcnv, the position adjustment of the seat element E forming the seat 30 of the transfer vehicle 22 is executed. For the position adjustment of the seat element E in the transfer vehicle 22, for example, as described above, the memory function implemented on the seat 30 can be used. Accordingly, the vehicle transfer assistance system 1 according to the present embodiment can secure the suitable sitting posture for the user 10 even after transferring between the vehicles 20.

Specifically, as shown in FIG. 4, in the vehicle transfer assistance system 1 according to the present embodiment, the adjustment position P of the seat element E acquired from the boarded vehicle 21 by the mobile terminal 40 of the user 10 is transmitted from the mobile terminal 40 to the service server 45. Further, in the service server 45, the converted adjustment position Pcnv based on the adjustment position P of the seat element E in the boarded vehicle 21 is generated. In the vehicle transfer assistance system 1 according to the present embodiment, when transferring between the vehicles 20, the converted adjustment position Pcnv generated by the service server 45 is transmitted to the mobile terminal 40 of the user 10 boarding on the transfer vehicle 22.

Specifically, the service server 45 of the present embodiment calculates a predetermined specific distance D around the seat 30 of the boarded vehicle 21 based on the adjustment position P acquired in the boarded vehicle 21. The specific distance D is associated with a physical feature of the user 10 sitting on the seat 30. In the vehicle transfer assistance system 1 according to the present embodiment, when transferring between the vehicles 20, the service server 45 calculates the above converted adjustment position Pcnv as the adjustment position P of the seat element E for reproducing the specific distance D on the transfer vehicle 22.

More specifically, as shown in FIGS. 2 and 3, the vehicle transfer assistance system 1 according to the present embodiment is applied in a case where the user 10 is the driver of the vehicle 20, that is, a case where the user 10 sits on the driver seat 70 as the seats 30 of the boarded vehicle 21 and the transfer vehicle 22. The service server 45 according to the present embodiment calculates, as the predetermined specific distance D around the seat 30, a separation distance Dp between a foot pedal 71 operated by the user 10 sitting on the driver seat 70 and a front end portion 72 of the seat cushion 32.

That is, the separation distance Dp between the foot pedal 71 disposed in front of the driver seat 70 and the front end portion 72 of the seat cushion 32 is associated with a length of a leg of the user 10 who is the driver. Further, in the boarded vehicle 21, the adjustment position P set in the seat cushion 32 as the seat element E forming the driver seat 70 is estimated to be a value adjusted by the user 10 such that the vehicle 20 can be easily driven in accordance with the length of the leg of the user. The vehicle transfer assistance system 1 according to the present embodiment reproduces the separation distance Dp between the foot pedal 71 and the front end portion 72 of the seat cushion 32 in the transfer vehicle 22, thereby securing the sitting posture in which the user 10 can easily drive even after the transfer.

Specifically, as shown in FIG. 4, the vehicle transfer assistance system 1 according to the present embodiment includes a conversion database 73 and a user database 74 provided in the service server 45.

As shown in FIG. 5, the conversion database 73 according to the present embodiment has a configuration in a data table format in which the specific distance D and the adjustment position P of the seat element E are stored in association with each other for each of a plurality of vehicles 20 that may be boarded by the user 10.

That is, by designating a target vehicle 20 and inputting the adjustment position P set in the seat element E, the conversion database 73 outputs the specific distance D obtained in the designated vehicle 20 according to the setting of the adjustment position P. Similarly, by designating the vehicle 20 that is the target and inputting the specific distance D, the conversion database 73 outputs the adjustment position P to be set in the seat element E of the designated vehicle 20 to obtain the specific distance D. Further, in the conversion database 73 according to the present embodiment, the separation distance Dp between the foot pedal 71 and the front end portion 72 of the seat cushion 32 is registered for each vehicle 20 as the specific distance D. Further, in the conversion database 73, the slide position Ps and the lift position PI of the seat cushion 32 are registered as the adjustment position P of the seat element E.

That is, the slide position Ps and lift position PI of the seat cushion 32 transmitted from the mobile terminal 40 of the user 10 to the service server 45 as the adjustment position P of the seat element E set in the boarded vehicle 21 are input to the conversion database 73. Further, at this time, information such as an identification number for identifying the vehicle 20 corresponding to the boarded vehicle 21 is also input to the conversion database 73. Accordingly, the vehicle transfer assistance system 1 according to the present embodiment calculates the separation distance Dp between the foot pedal 71 and the front end portion 72 of the seat cushion 32 as the specific distance D around the driver seat 70 in the boarded vehicle 21.

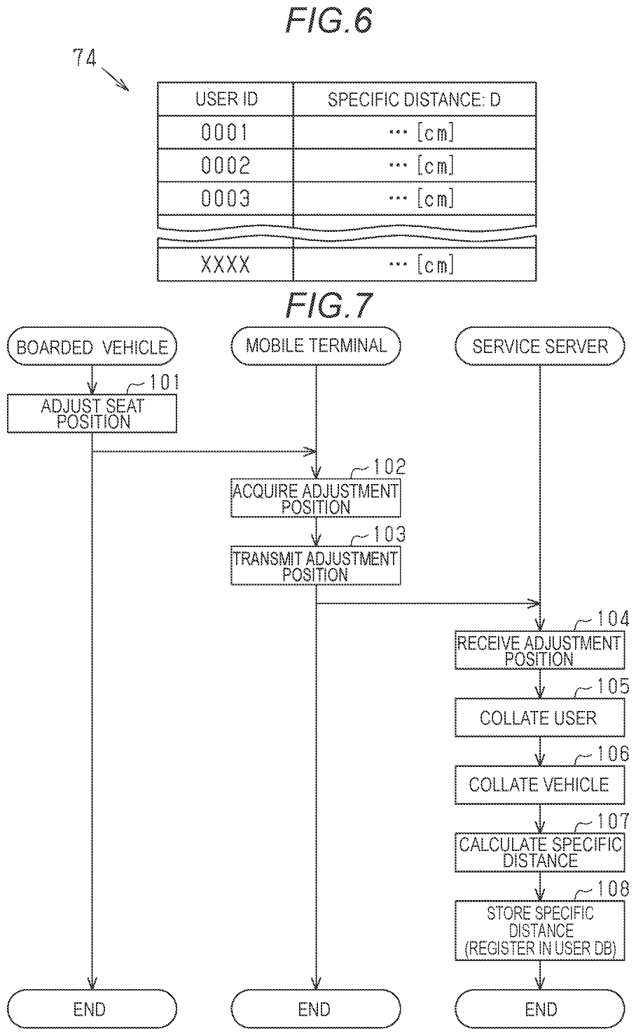

As shown in FIG. 6, the user database 74 according to the present embodiment stores the user 10 and the specific distance D in association with each other in the data table format. In the vehicle transfer assistance system 1 according to the present embodiment, the specific distance D in the boarded vehicle 21 calculated as described above is registered in the user database 74 together with information such as an identification number for specifying the user 10.

Further, in the vehicle transfer assistance system 1 according to the present embodiment, when the user 10 transfers between the vehicles 20, the service server 45 reads the specific distance D in association with the user 10 from the user database 74. Further, the service server 45 inputs information such as an identification number for specifying the vehicle 20 serving as the transfer vehicle 22, together with the specific distance D, to the conversion database 73. Accordingly, the vehicle transfer assistance system 1 according to the present embodiment calculates the slide position Ps and the lift position PI to be set in the seat cushion 32 as the converted adjustment position Pcnv for reproducing the specific distance D in the driver seat 70 of the transfer vehicle 22.

Next, a function of the vehicle transfer assistance system 1 according to the present embodiment configured as described above will be described.

As shown in FIG. 7, in the vehicle transfer assistance system 1 according to the present embodiment, when the seat position adjustment is performed in the driver seat 70 of the boarded vehicle 21 (step 101), the adjustment position P of the set seat element E is acquired by the mobile terminal 40 of the user 10 (step 102). The adjustment position P of the seat element E acquired from the boarded vehicle 21 is transmitted from the mobile terminal 40 to the service server 45 (step 103).

Next, when the service server 45 receives the adjustment position P of the seat element E transmitted by the mobile terminal 40 (step 104), the user 10 thereof is collated (step 105), and the vehicle 20 corresponding to the boarded vehicle 21 is collated (step 106). Further, based on the adjustment position P of the seat element E received from the mobile terminal 40, the specific distance D around the driver seat 70 obtained in the boarded vehicle 21 by setting the adjustment position P is calculated (step 107). The calculation of the specific distance D is performed by inputting the adjustment position P of the seat element E in the boarded vehicle 21 received from the mobile terminal 40 together with the information of the vehicle 20 corresponding to the boarded vehicle 21 specified by the collation in step 106 to the conversion database 73. The specific distance D calculated in step 107 is input to the user database 74 together with the information of the user 10 specified by the collation in step 105, and is stored in association with the user 10 (step 108).

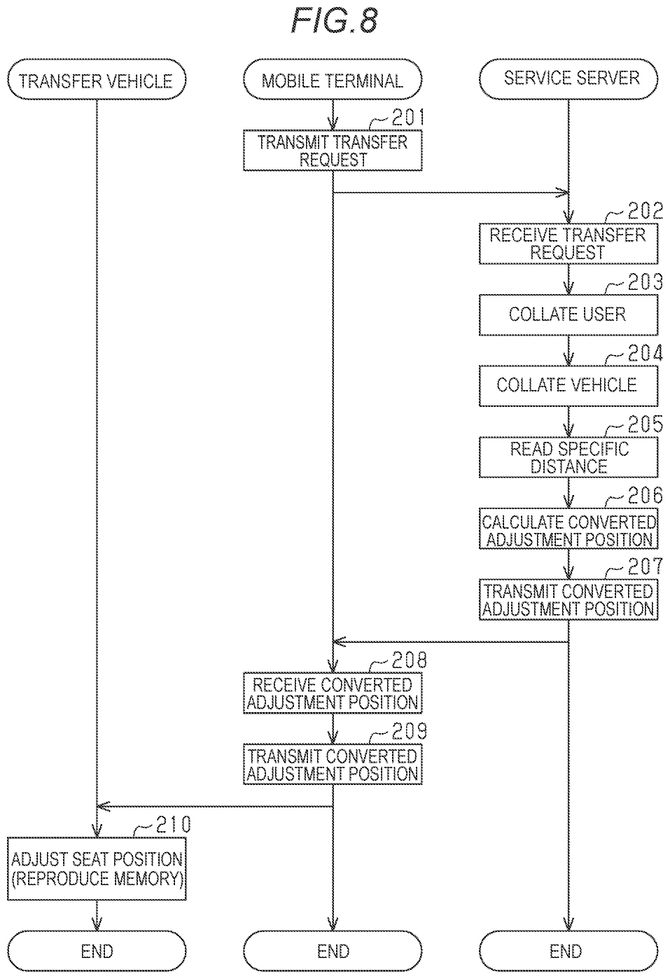

As shown in FIG. 8, in the vehicle transfer assistance system 1 according to the present embodiment, when the user 10 transfers between the vehicles 20, a transfer request is transmitted from the mobile terminal 40 to the service server 45 (step 201). Next, when the service server 45 receives the transfer request transmitted by the mobile terminal 40 (step 202), the user 10 indicated in the transfer request is collated (step 203), and the vehicle 20 corresponding to the transfer vehicle 22 is collated (step 204). Further, the specific distance D in association with the user 10 collated in step 203 is read from the user database 74 (step 205). The specific distance D is input to the conversion database 73 together with the information of the vehicle 20 corresponding to the transfer vehicle 22 specified by the collation, and thereby the converted adjustment position Pcnv for reproducing the specific distance D on the driver seat 70 of the transfer vehicle 22 is calculated (step 206).

Next, the converted adjustment position Pcnv calculated in the service server 45 is transmitted to the mobile terminal 40 of the user 10 (step 207). The converted adjustment position Pcnv received in the mobile terminal 40 (step 208) is further transmitted to the transfer vehicle 22 (step 209). Then, based on the converted adjustment position Pcnv, the seat position adjustment of the driver seat 70 in the transfer vehicle 22 is executed (step 210).

Specifically, the operations of the seat slide device 51 and lifter device 52 provided in the driver seat 70 of the transfer vehicle 22 are controlled, with the slide position Ps and the lift position PI of the seat cushion 32 indicated by the converted adjustment position Pcnv as the control target.

In the vehicle transfer assistance system 1 according to the present embodiment, the converted adjustment position Pcnv received by the transfer vehicle 22 is written into the storage area 65m of the control device 65 which controls the operations of the seat slide device 51 and lifter device 52. Further, when the transfer vehicle 22 is started, the control device 65 executes operation control of the seat slide device 51 and the lifter device 52 by the memory function with the converted adjustment position Pcnv written into the storage area 65m as the adjustment position P to be stored, that is, memory reproduction. Accordingly, in the vehicle transfer assistance system 1 according to the present embodiment, the separation distance Dp between the foot pedal 71 and the front end portion 72 of the seat cushion 32 as the specific distance D around the driver seat 70 in the boarded vehicle 21 is reproduced in the driver seat 70 of the transfer vehicle 22.

Next, effects of the present embodiment will be described.

(1) The vehicle transfer assistance system 1 uses the mobile terminal 40 of the user 10 as the adjustment position acquisition unit 1a, and acquires the adjustment position P of the seat element E set in the boarded vehicle 21 by the user 10 through communication between the mobile terminal 40 and the boarded vehicle 21 boarded by the user 10. In the vehicle transfer assistance system 1, through the communication between the mobile terminal 40 and the service server 45, the service server 45 functions as a specific distance calculation unit 1b, a specific distance storing unit 1c, and a converted adjustment position calculation unit 1d.

The service server 45 as the specific distance calculation unit 1b calculates the predetermined specific distance D around the seat 30 associated with the physical feature of the user 10 seated in the seat 30 of the boarded vehicle 21 formed by the seat element E based on the adjustment position P acquired by the mobile terminal 40. Further, the service server 45 as the specific distance storing unit 1c stores the specific distance D and the user 10 in association with each other. When the user 10 boards on the transfer vehicle 22 different from the boarded vehicle 21, the service server 45 as the converted adjustment position calculation unit 1d calculates the converted adjustment position Pcnv as the adjustment position P set for the seat element E in order to reproduce the specific distance D on the transfer vehicle 22.

That is, in the boarded vehicle 21, the adjustment position P set for the seat element E forming the seat 30 is estimated to be a value adjusted by the user 10 per se to obtain a suitable sitting posture in accordance with the physical feature associated with the specific distance D around the seat 30. Therefore, by reproducing the specific distance D on the transfer vehicle 22, it is possible to secure the suitable sitting posture even after the transfer.

Such reproduction of the specific distance D has an advantage of being hardly affected even when the vehicle design of the boarded vehicle 21 to be transferred from is different from the vehicle design of the transfer vehicle 22. Further, by calculating the specific distance D around the seat 30 from the adjustment position P of the seat element E set in the boarded vehicle 21, a distance measurement device such as a built-in camera is unnecessary. Accordingly, it is possible to support transfer between various vehicle designs and more vehicles 20.

(2) The service server 45 calculates, as the specific distance D around the seat 30 in the boarded vehicle 21, the separation distance Dp between the foot pedal 71 operated by the user 10 sitting on the driver seat 70 and the front end portion 72 of the seat cushion 32. Further, the service server 45 calculates the slide position Ps and the lift position PI to be set in the seat cushion 32 as the converted adjustment position Pcnv for reproducing the separation distance Dp in the driver seat 70 of the transfer vehicle 22. The service server 45 transmits the converted adjustment position Pcnv to the mobile terminal 40 of the user 10.

That is, the separation distance Dp between the foot pedal 71 disposed in front of the driver seat 70 and the front end portion 72 of the seat cushion 32 is associated with the length of the leg of the user 10 who is the driver. Further, in the boarded vehicle 21, the adjustment position P set in the seat cushion 32 as the seat element E forming the driver seat 70 is estimated to be the value adjusted by the user 10 such that the vehicle 20 can be easily driven in accordance with the length of the leg of the user. Therefore, according to the above configuration, it is possible to secure the sitting posture in which the user 10 can easily drive even after the transfer.

(3) In the vehicle transfer assistance system 1, the converted adjustment position Pcnv is transmitted from the mobile terminal 40 of the user 10 to the transfer vehicle 22. Accordingly, the seat slide device 51 and the lifter device 52 provided in the driver seat 70 of the transfer vehicle 22 and the control device 65 which controls the operations of the seat slide device 51 and the lifter device 52 function as the transfer position adjustment drive control unit 1e. The operations of the seat slide device 51 and lifter device 52 are controlled with the slide position Ps and the lift position PI of the seat cushion 32 indicated by the converted adjustment position Pcnv as the control target.

According to the above configuration, when transferring between the vehicles 20, optimal seat position adjustment is automatically executed in the transfer vehicle 22. Accordingly, it is possible to easily secure the suitable sitting posture after the transfer.

(4) The service server 45 includes the conversion database 73 that stores, for each of the vehicles 20, the specific distance D and the adjustment position P of the seat element E in association with each other.

According to the above configuration, it is possible to use a simple configuration to easily calculate the predetermined specific distance D around the seat 30 based on the adjustment position P of the seat element E set by the user 10 in the boarded vehicle 21. When transferring to another vehicle, the converted adjustment position Pcnv for reproducing the specific distance D on the transfer vehicle 22 can be calculated based on the specific distance D in association with the user 10.

The above embodiment can be implemented in a manner modified as follows. The above embodiment and the following modifications can be performed in combination with each other within a technically consistent range.

In the above embodiment, the separation distance Dp between the foot pedal 71 operated by the user 10 sitting on the driver seat 70 and the front end portion 72 of the seat cushion 32 is calculated as the predetermined specific distance D around the seat 30. However, this disclosure is not limited thereto, and may adopt a configuration in which the separation distance between another driving operation member disposed around the driver seat 70 and a specific part of the driver seat 70 is calculated as the specific distance D.

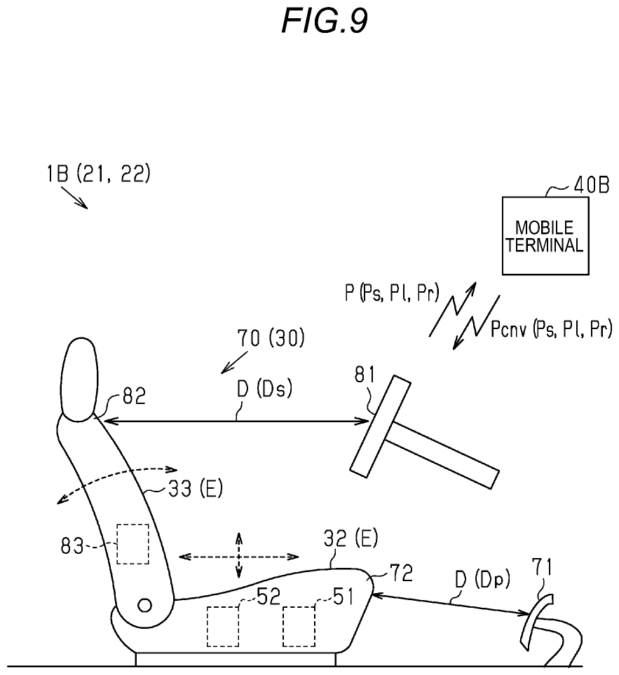

For example, as shown in FIG. 9, based on the adjustment position P of the seat element E set in the boarded vehicle 21 by the user 10, the separation distance Ds between a driving handle 81 operated by the user 10 sitting on the driver seat 70 and a shoulder portion 82 of a seatback 33 constituting the driver seat 70 is calculated. The separation distance Ds is used as the predetermined specific distance D around the seat 30 associated with the physical feature of the user 10 sitting on the seat 30 of the boarded vehicle 21.

That is, the separation distance Ds between the driving handle 81 disposed in front of the driver seat 70 and the shoulder portion 82 of the seatback 33 is associated with a length of an arm of the user 10 who is the driver. In the boarded vehicle 21, the adjustment position P set in the seatback 33 as the seat element E forming the driver seat 70 is estimated to be the value adjusted by the user 10 such that the vehicle 20 can be easily driven in accordance with the length of the arm of the user.

In view of this point, in a vehicle transfer assistance system 1B of this alternative embodiment, the mobile terminal 40B of the user 10 acquires a reclining position Pr of the seatback 33 constituting the driver seat 70 as the adjustment position P of the seat element E set in the boarded vehicle 21. Further, based on the reclining position Pr, the converted adjustment position Pcnv for reproducing the separation distance Ds between the driving handle 81 and the shoulder portion 82 of the seatback 33 in the transfer vehicle 22 is calculated as the specific distance D around the driver seat 70. The reclining position Pr of the seatback 33 is adjusted by controlling an operation of a recliner device 83 provided in the driver seat 70 of the transfer vehicle 22 based on the converted adjustment position Pcnv.

For convenience, FIG. 9 illustrates both the boarded vehicle 21 and the transfer vehicle 22, which, however, are different and independent vehicles 20. Also in the vehicle transfer assistance system 1B of the alternative embodiment, the adjustment position P of the seat element E transmitted from the mobile terminal 40B to the service server 45 includes the slide position Ps and lift position PI of the seat cushion 32. Similarly, the converted adjustment position Pcnv received by the mobile terminal 40B also includes the slide position Ps and lift position PI of the seat cushion 32 for reproducing the separation distance Dp between the foot pedal 71 and the front end portion 72 of the seat cushion 32 on the transfer vehicle 22. Accordingly, the vehicle transfer assistance system 1B of the alternative embodiment can secure the suitable sitting posture for the user 10 even after transferring between the vehicles 20.

As the specific distance D around the driver seat 70, the converted adjustment position Pcnv for reproducing the separation distance Ds between the driving handle 81 and the shoulder portion 82 of the seatback 33 in the transfer vehicle 22 may be calculated alone. Further, the slide position Ps of the seat cushion 32 may be calculated alone as the specific distance D. When a tilt position of the seat cushion 32 and an extension position of the sitting surface can be adjusted, these values may be calculated as the specific distance D.

The adjustment position P of the seat element E configured to be adjustable may be applied to transfer between vehicles 20 having different contents from each other. For example, in the boarded vehicle 21, the slide position Ps and lift position PI of the seat cushion 32 are acquired as the adjustment position P of the seat element E. For the transfer vehicle 22, the slide position Ps of the seat cushion 32 may be calculated alone as the converted adjustment position Pcnv. That is, as long as the specific distance D around the driver seat 70 in the boarded vehicle 21 can be reproduced in the driver seat 70 of the transfer vehicle 22, the form and the number of the seat element E whose position is to be adjusted may be different between the boarded vehicle 21 and the transfer vehicle 22.

In the above embodiment, the conversion database 73 which stores the specific distance D and the adjustment position P of the seat element E in association with each other is used for the calculation of the converted adjustment position Pcnv for each vehicle 20. However, this disclosure is not limited thereto, may have the calculation method changed to any method as long as the specific distance D around the driver seat 70 in the boarded vehicle 21 can be reproduced in the driver seat 70 of the transfer vehicle 22. For example, the converted adjustment position Pcnv may be calculated such that the form of the seat element E whose position is to be adjusted is selected such that the specific distance D can be reproduced most quickly. Further, directivity of the lift position PI is learned from history of the seat position adjustment performed by the user 10, such as not to adjust the lift position P1. The converted adjustment position Pcnv may be calculated such that the form of the seat element E whose position is to be adjusted is selected according to the directivity of the user 10.

In the above embodiment, the seat position adjustment based on the converted adjustment position Pcnv in the transfer vehicle 22 is executed by the memory reproduction at the time of starting. However, this disclosure is not limited thereto, and for example, the seat position adjustment based on the converted adjustment position Pcnv may be executed in a mode in which the operation control of the seat slide device 51 and the lifter device 52 is started in response to a request from the user 10.

The seat position adjustment based on the converted adjustment position Pcnv is not necessarily automatically executed by the operation of the actuator 60 having the drive source. A configuration may be adopted in which a seat position adjustment method is exhibited such that the user 10 per se can reproduce the specific distance D around the driver seat 70 in the boarded vehicle 21 on the driver seat 70 of the transfer vehicle 22 based on the converted adjustment position Pcnv. For example, the seat element E to be adjusted and an adjustment mode thereof may be exhibited together with operation time of the operation switch 66. At this time, an operation timing of the operation switch 66 may be instructed. The converted adjustment position Pcnv may be visually expressed in the transfer vehicle 22.

The above embodiment is applied in a case where the user 10 sits on the driver seat 70 as the seat 30 of the boarded vehicle 21 and the transfer vehicle 22. However, this disclosure is not limited thereto, and may be applied in a case where the user 10 sits on a seat 30 other than the driver seat 70, such as a passenger seat or a rear seat.

When the seat 30 on which the user 10 sits is the passenger seat, a separation distance between a dashboard located in front of the seat 30 and the front end portion 72 of the seat cushion 32 may be calculated as the predetermined specific distance D around the seat 30. In this case, the specific distance D is associated with the length of the leg of the user 10. A separation distance between a headrest of the seat 30 or the sitting surface of the seat cushion 32 and a ceiling of the vehicle 20 may be calculated as the specific distance D. In this case, the specific distance D is associated with a sitting height of the user 10. Further, when the seat 30 on which the user 10 sits is a rear seat, a separation distance between the front end portion 72 of the seat cushion 32 forming the rear seat and the rear end portion of the seat cushion 32 forming the front seat may be calculated. In this case, the specific distance D is associated with the length of the leg of the user 10, specifically, a length up to a knee.

The communication between the mobile terminal 40 of the user 10 and the vehicle 20 may be performed via the Internet or may be performed directly between the mobile terminal 40 and the vehicle 20 through short-range communication.

For example, the adjustment position P of the seat element E set in the boarded vehicle 21 may be acquired by analyzing a captured image, for example, by the user 10 capturing the inside of the vehicle cabin using the camera of the mobile terminal 40. By adopting such a configuration, it is possible to support the transfer from a vehicle 20 including a manual seat position adjustment mechanism.

In the above embodiment, in the service server 45, the specific distance D around the seat 30 in the boarded vehicle 21 based on the adjustment position P acquired by the mobile terminal 40 of the user 10 is calculated, and the specific distance D and the user 10 are stored in association with each other. Also at the time of transfer, the converted adjustment position Pcnv for reproducing the specific distance D in the transfer vehicle 22 is calculated in the service server 45. However, this disclosure is not limited thereto, and at least one of calculation of the specific distance D, storing of the specific distance D, and calculation of the converted adjustment position Pcnv may be performed by the mobile terminal 40 or the vehicle 20. A vehicle transfer assistance system having the same function as that of the above embodiment may be constructed by the mobile terminal 40 of the user 10 and the vehicle 20 without involving the service server 45.

A vehicle transfer assistance system having the same function as that of the above embodiment may be constructed by communication between the vehicle 20 and the service server 45 without involving the mobile terminal 40 of the user 10. The user 10 in this case may be collated by, for example, information input by the user 10 or biometric authentication using a camera or the like provided in the vehicle 20. Alternatively, mutual communication may be performed between a plurality of vehicles 20, so as to construct a vehicle transfer assistance system having the same function as that of the above embodiment by the vehicles 20.

The above embodiment is embodied as the vehicle transfer assistance system 1 used for car sharing, car rental services, and the like. However, this disclosure is not limited thereto, and may be used at the time of purchase, lending, or the like of the vehicle 20 by an individual owner.

According to an aspect of this disclosure, a vehicle transfer assistance system includes: an adjustment position acquisition unit configured to acquire an adjustment position of a seat element set in a boarded vehicle boarded by a user; a specific distance calculation unit configured to calculate, based on the acquired adjustment position, a predetermined specific distance around a seat of the boarded vehicle formed by the seat element, the specific distance being associated with a physical feature of the user sitting on the seat; a specific distance storing unit configured to store the user and the specific distance in association with each other; and a converted adjustment position calculation unit configured to calculate a converted adjustment position that is the adjustment position of the seat element for reproducing the specific distance in a transfer vehicle different from the boarded vehicle when the user boards on the transfer vehicle.

That is, in the boarded vehicle, the adjustment position set for the seat element forming the seat is estimated to be a value adjusted by the user per se to obtain a suitable sitting posture in accordance with the physical feature associated with the specific distance around the seat. Therefore, by reproducing the specific distance in the transfer vehicle, it is possible to secure the suitable sitting posture even after the transfer.

Such reproduction of the specific distance has an advantage of being hardly affected even when vehicle design of the boarded vehicle to be transferred from is different from vehicle design of the transfer vehicle. Further, by calculating the specific distance around the seat from the adjustment position of the seat element set in the boarded vehicle, a distance measurement device such as a built-in camera is unnecessary. Accordingly, it is possible to support transfer between various vehicle designs and more vehicles.

In the vehicle transfer assistance system according to the above aspect, it is preferable that the converted adjustment position calculation unit calculates a slide position of the seat element and a lift position of the seat element as the converted adjustment position.

In the vehicle transfer assistance system according to the above aspect, it is preferable that the specific distance calculation unit calculates, as the specific distance, a separation distance between a foot pedal operated by the user sitting on a driver seat and a front end portion of a seat cushion.

That is, the separation distance between the foot pedal disposed in front of the driver seat and the front end portion of the seat cushion is associated with a length of a leg of the user who is the driver. Further, in the boarded vehicle, the adjustment position set in the seat cushion as the seat element forming the driver seat is estimated to be a value adjusted by the user such that the vehicle can be easily driven in accordance with the length of the leg of the user. Therefore, according to the above configuration, it is possible to secure the sitting posture in which the user can easily drive even after the transfer.

In the vehicle transfer assistance system according to the above aspect, it is preferable that the specific distance calculation unit calculates, as the specific distance, a separation distance between a driving handle operated by the user sitting on the driver seat and a shoulder portion of a seatback.

That is, the separation distance between the driving handle disposed in front of the driver seat and the shoulder portion of the seatback is associated with a length of an arm of the user who is the driver. In the boarded vehicle, the adjustment position set in the seatback as the seat element forming the driver seat is estimated to be a value adjusted by the user such that the vehicle can be easily driven in accordance with the length of the arm of the user. Therefore, according to the above configuration, it is possible to secure the sitting posture in which the user can easily drive even after the transfer.

The vehicle transfer assistance system according to the above aspect preferably further includes a transfer position adjustment drive control unit that drives the seat element of the transfer vehicle based on the converted adjustment position to reproduce the specific distance around the seat.

In the above configuration, when transferring to another vehicle, an optimal seat position adjustment is automatically executed in the transfer vehicle. Accordingly, it is possible to easily secure the suitable sitting posture after the transfer.

The vehicle transfer assistance system according to the above aspect preferably further includes a conversion database that stores the specific distance and the adjustment position in association with each other for each of a plurality of vehicles.

According to the above configuration, it is possible to use a simple configuration to easily calculate a predetermined specific distance around the seat based on the adjustment position of the seat element set by the user in the boarded vehicle. When transferring to another vehicle, the converted adjustment position for reproducing the specific distance in the transfer vehicle can be calculated based on the specific distance in association with the user.

In the vehicle transfer assistance system according to the above aspect, it is preferable that the physical feature is a length of a leg of the user.

In the vehicle transfer assistance system according to the above aspect, it is preferable that the physical feature is a length of an arm of the user.

According to the above aspect of this disclosure, it is possible to secure the suitable sitting posture even after transferring between vehicles.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle transfer assistance system, comprising:
an adjustment position acquisition unit configured to acquire an adjustment position of a seat element set in a boarded vehicle boarded by a user;
a specific distance calculation unit configured to calculate, based on the acquired adjustment position, a predetermined specific distance around a seat of the boarded vehicle formed by the seat element, the specific distance being associated with a physical feature of the user sitting on the seat;
a specific distance storing unit configured to store the user and the specific distance in association with each other; and
a converted adjustment position calculation unit configured to calculate a converted adjustment position that is the adjustment position of the seat element for reproducing the specific distance in a transfer vehicle different from the boarded vehicle when the user boards on the transfer vehicle.

2. The vehicle transfer assistance system according to claim 1, wherein
the converted adjustment position calculation unit calculates a slide position of the seat element and a lift position of the seat element as the converted adjustment position.

3. The vehicle transfer assistance system according to claim 1, wherein
the specific distance calculation unit calculates, as the specific distance, a separation distance between a foot pedal operated by the user sitting on a driver seat and a front end portion of a seat cushion.

4. The vehicle transfer assistance system according to claim 1, wherein
the specific distance calculation unit calculates, as the specific distance, a separation distance between a driving handle operated by the user sitting on a driver seat and a shoulder portion of a seatback.

5. The vehicle transfer assistance system according to claim 1, further comprising:
a transfer position adjustment drive control unit configured to drive the seat element of the transfer vehicle based on the converted adjustment position to reproduce the specific distance around the seat.

6. The vehicle transfer assistance system according to claim 1, further comprising:
a conversion database configured to store the specific distance and the adjustment position in association with each other for each of a plurality of vehicles.

7. The vehicle transfer assistance system according to claim 1, wherein
the physical feature is a length of a leg of the user.

8. The vehicle transfer assistance system according to claim 1, wherein
the physical feature is a length of an arm of the user.
